(19) United States
(12) Patent Application Publication
(10) Pub. No.: US 2005/0018434 A1
(43) Pub. Date: Jan. 27, 2005

(54) Positional luminaire

(76) Inventor: Ronald Giuliano, New Hyde Park, NY (US)

Correspondence Address: DILWORTH & BARRESE, LLP, 333 EARLE OVINGTON BLVD., UNIONDALE, NY, 11553, US

(21) Appl. No.: 10/858,257

(22) Filed: Jun. 1, 2004

Related U.S. Application Data
(60) Provisional application No. 60/474,853, filed on May 30, 2003.

(51) Int. Cl. F21V 1/00

(52) U.S. Cl. 362/372

(57) ABSTRACT

A positional luminaire is disclosed having a housing encompassing one or more LEDs within a luminaire for providing desired illumination patterns. Within the luminaire is housing and an LED holder, which can act as a heat sink and is moveable by a positioning mechanism. Arranging additional LEDs to the positioning structure eliminates hot spots and increases light intensity. Fixed LEDs are alternatively provided, either in addition to or in lieu of the positioning mechanism. Light guides and lenses can be provided for near surface or other desired illumination. Lenses can be coated, etched, colorized or stenciled to perceptibly enhance the positional luminaire. Additionally, filters can be used to achieve a specific lighting luminance.

This application claims priority to a provisional application, which was filed on May 30, 2003 with the U.S. Patent and Trademark Office and was assigned application Ser. No. 60/474,853, the contents of which are incorporated by reference.

### FIELD OF INVENTION

The present invention relates to directional lighting fixtures, and to providing illumination by positioning and arrangement of a light source, including light emitting diode(s) (LEDs) within a luminaire housing and similar structure.

### DESCRIPTION OF THE RELATED ART

Conventional bulbs typically produce essentially a 360° degree pattern of light output. While acceptable for ambient lighting, conventional bulbs are not conducive to focusing light in a particular direction. In order to direct the light output in a desired direction, a rear reflector 100 is commonly used with an incandescent, florescent or halogen bulb 102, as shown in FIG. 1.

FIG. 1 depicts a conventional luminaire having a rear reflector to focus the output beam upon an illumination point. The rear reflector directs most of the light 104 at a desired target (i.e. illumination point). A problem associated with use of a rear reflector 100 is that the relative location of the bulb 102. If the illumination point is moved, however, the housing 106 must be moved an appropriate distance. If the bulb 102 is moved within the reflector housing 110, a loss of intensity at the illumination point and scattered light 112 results, as shown in FIG. 2. FIG. 2 shows a conventional luminaire in which the light source has been shifted upward relative to the reflector structure, and the resultant scattered light beam pattern

Numerous devices have been suggested for moving a lamp socket within an assembled fixture to focus output light upon an illumination point, such by providing pivoting, rotating and sliding shades. For example, U.S. Pat. No. 3,660,651 discloses an adjustable light shade for directing light at various angles toward an object; U.S. Pat. No. 3,590,238 discloses a socket positioner for horizontally and vertically positioning the socket within the luminaire; U.S. Pat. No. 4,300,187 discloses a reflector mounted for selective adjustment to different positions relative to a light source; U.S. Pat. No. 5,017,327 discloses an adjusting mechanism for focusing a light beam utilizing a screw within a threaded piston; U.S. Pat. No. 5,086,379 discloses a low voltage outdoor floodlight having adjustable beam pattern; U.S. Pat. No. 5,523,932 discloses a lighting fixture with adjustable reflector; U.S. Pat. No. 6,517,216 discloses an adjustable fluorescent lighting fixture; and U.S. Pat. No. 6,652,118 discloses an asymmetric distribution luminaire; the disclosure of which are incorporated herein by reference.

As indicated by the above conventional systems, it is difficult to adjust an illumination pattern to match the shape of more than one intended target. For example, a square picture hung on a wall is inefficiently lit by a common round beam pattern, a highway lighting housing will typically cast round beam patterns onto parallel roadways, and automobile headlights output two round beam patterns, which often fail to illuminate the entire roadbed ahead of the vehicle. For example, U.S. Pat. No. 6,428,187 proposes a vehicle light beam adjusting device, the disclosure of which is incorporated by reference. In the device of U.S. Pat. No. 6,428,187 a light bulb is moved relative to a reflector to adjust the vehicle light beam. This light beam-adjusting device, however, requires use of a reflector, and is adjustable along only a single plane.

Lenses, filters or masks have been used to reshape and redistribute light output. Lenses, however, use fixed position bulbs and require repositioning of all of the lens, bulb and reflector. Filters or masks inefficiently reduce or block output light.

Conventional lighting sources have inherent limitations. For example, incandescent bulbs are inefficient, give off heat and waste energy. Halogen bulbs, though more efficient, run extremely hot and can pose a fire hazard. Although florescent bulbs give off less heat, they require a step up transformer, which wastes energy and presents dangerous voltages at the connecting sockets.

LED lighting provides an economical way to illuminate objects. The average lifetime for an LED is approximately 10 years, far above that for conventional bulb. Either an AC or DC power source may drive the LEDs, providing broad design flexibility. LEDs come in various colors and brightness, and some provide a strobing effect. Numerous types of LEDs are available for use in various applications and to achieve desired effects. Lower power, higher brightness LEDs save energy, run cool to the touch and operate at safe, low voltages. Higher brightness LEDs make it possible to illuminate objects at a distance.

The low power requirement of the LEDs makes the positional luminaire environmentally friendly. Cool running temperature of the LEDs requires less cooling and allows LEDs to utilize low voltages, make it less likely to pose a fire risk, thereby making it safer and more economical. Further, LEDs can be dimmed without resultant ringing noise typical of filament-based sources, lending the invention to applications where noise is of concern, such as home theaters.

Output of conventional LEDs is measured in micro-candaliers, and output of newer LEDs is measured in lumens. Such newer, high lumen output LEDs produce a cost and energy efficient means of illumination.

The present invention allows a small shift in position of the LED to appropriately reposition the illumination point, without having to move the entire housing and without the need for a rear reflector. In contrast to conventional systems, a shift in LED position will not significantly affect the relative intensity or the beam pattern.

The method of the present invention allows use of a standardized luminaire having readily adjustable output light that matches a plurality of projects, is useful numerous lighting applications, and is economical to manufacture and utilize.

### SUMMARY OF THE INVENTION

The positional luminaire of the present invention has many advantages over conventional lighting. For example, the positional luminaire provides the ability to position the light beam at a given target without moving the housing or reflector, and without having to disassemble the assembly to adjust the final beam pattern.

Further, the positional luminaire of the present invention provides the ability to closely match a given target with a proper beam pattern of illumination. This is of particular use, for example, illuminating highways. Beam patterns of conventional highway illumination systems inefficiently illuminate the rectangular-shaped highway roadways, are inefficient and create unwanted light pollution. In contrast, the present invention makes it possible to more fully illuminate a roadway with a rectangular beam pattern, without having to reposition or specifically adjust extant highway lampposts. Rather, the positional luminaire of the present invention would sit atop existing lampposts and the output light beam can be positioned (i.e. shifted) to better illuminate the roadbed. The roadway would be more continuous framed with a matching lighting pattern, in contrast to the overlapping oval beam pattern of conventional systems.

A still further object of the present invention is to provide compact, integral and economical LED-based lighting method using lenses, filters and masks to reshape, refocus and distribute the resultant light beam with a given illumination pattern. In addition, lenses and light guides can be used to closely match the beam pattern to an intended target, providing an important advantage.

Yet a further object of the present invention is to provide LEDs closely juxtaposed and arranged in three dimensions so that light can be focused by selectively illuminating the LEDs, without the need to physical relocate the light source within the housing, or to reposition the housing itself.

### BRIEF DESCRIPTION OF THE DRAWINGS

For a better understanding of the invention as well as other objects and further features thereof, reference is made to the following detailed description to be read in conjunction with the accompanying drawings, wherein:

FIG. 1 depicts a conventional luminaire having a rear reflector to focus the output beam upon an illumination point;

FIG. 2 shows a conventional luminaire in which the light source has been shifted upward relative to the reflector structure, and the resultant scattered light beam pattern;

FIG. 3 provides an outline of a control system for the positional luminaire of the present invention;

FIG. 4 describes the position of a light source within the positional luminaire;

FIG. 5 shows a plurality of LEDs within the positional luminaire, and shows the resultant change in the illumination point and pattern when the light source is repositioned;

FIGS. 6, 7 and 8 provide examples of the relatively large change in the position and/or shape of the illumination point that can be achieved by shifting the light source a relatively small amount;

FIGS. 9 and 10 illustrate a rod lens that can be used with the positional luminaire of the present invention;

FIG. 11 illustrates a conical lens that can be used with the positional luminaire of the present invention;

FIGS. 12A and 12B provide front and top views of the positional luminaire utilizing a rod lens and three light sources;

FIGS. 13A and 13B provide front and top views of the positional luminaire with a rod lens corresponding to each light source;

FIG. 14 shows the positional luminaire further provided with a fixed light source;

FIG. 15 is a side view of the positional luminaire consisting of three light sources that are fixedly positioned;

FIG. 16A is a front view of the luminaire of FIGS. 12A and 12B in which longitudinal edges of a rod lens have been etched; and

FIG. 16B illustrates mounting the luminaire of FIG. 16A upon a roadway lamppost.

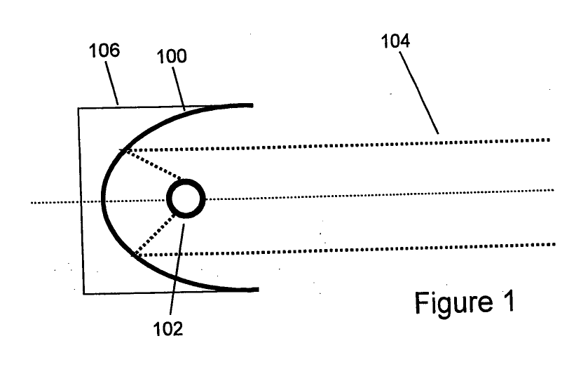

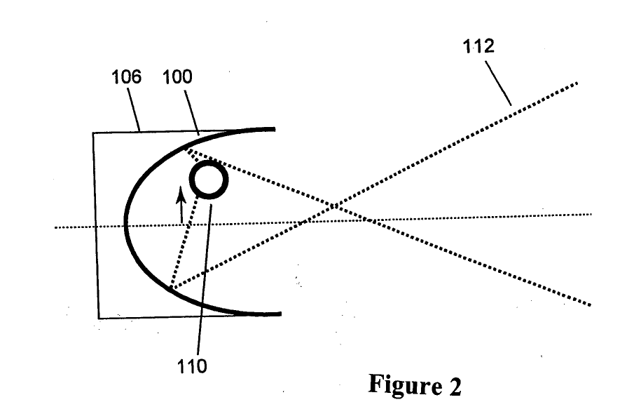

### DETAILED DESCRIPTION OF THE PREFERRED EMBODIMENTS

The following detailed description of preferred embodiments of the invention will be made in reference to the accompanying drawings. In describing the invention, explanation of related functions and constructions that are known in the art have been omitted to avoid obscuring the concept of the invention with unnecessary detail.

The luminaire of the present invention comprises a lighting fixture having a housing 120 having an interior cavity. The lighting source is preferably LED-based, can be provided by fiber optic source, or can be provided via a plurality of LEDs. Use of an LED light source is preferred, thereby obtaining the advantage of its conically shaped light output.

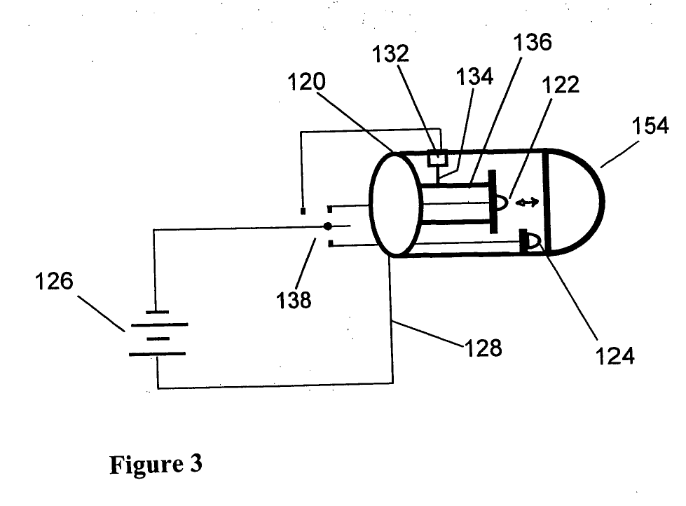

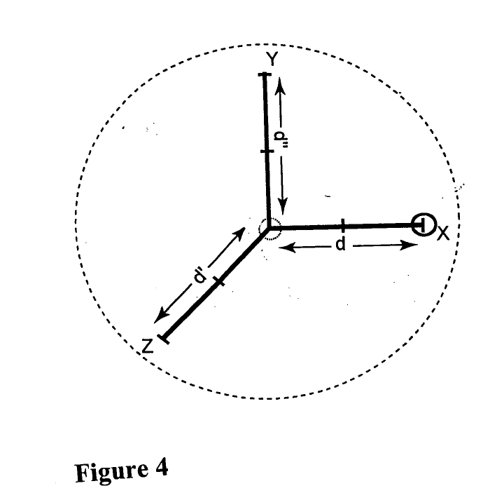

A positional structure or LED holder is positioned in and is controllably moveable within the interior cavity to allow a user to control the movement and adjustment of the light source. An outline of a control system for the positional luminaire of the present invention is provided by FIG. 3. Adjustment of the positional luminaire is preferably provided in all three directions, i.e. in horizontal (x), vertical (y) and longitudinal (z) directions, as shown in FIG. 4, which describes the position of the light source within the positional luminaire.

The housing 120 encloses holder 136 in a predetermined home position. The holder is moveable between the plurality of enhanced lighting positions preferably via an electro-mechanical screw drive 134 that can be driven in the vertical direction by a conventional stepper motor 132, can be driven in the horizontal direction by stepper motor within the holder 136, and can be driven in the longitudinal direction by a third stepper motor (not shown in FIG. 3). A light source is fixedly mounted to the holder, and movement of the holder focuses the light output.

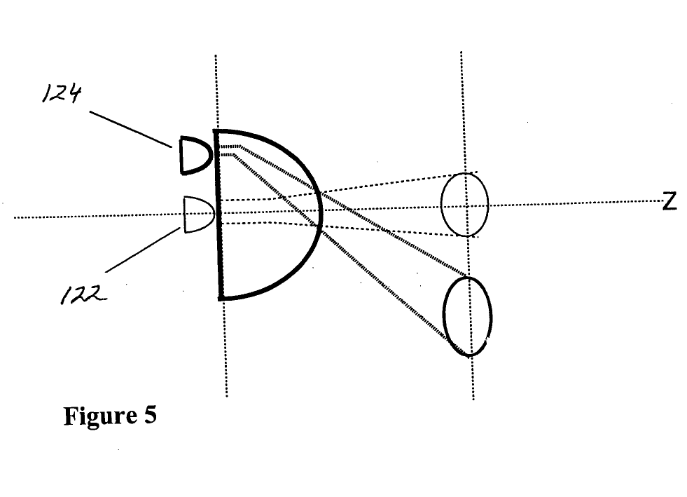

FIG. 5 shows a plurality of light sources within the positional luminaire, and shows the resultant change in the illumination point and pattern when the light source is repositioned. As shown in FIGS. 4 and 5, an additional/fixed light source 124 is preferably further provided, and separate illumination of the additional/fixed light source 124 eliminate dead spots to be illuminated in a given target (i.e. illumination point), and allows for a more evenly and distinct illumination pattern.

If the illumination point is moved, a small change in position of the LEDs behind the fixed lens produces a large change of position, in the opposite direction for the resultant beam of light in front of the lens, but without loss of relative beam width, illumination pattern or light intensity.

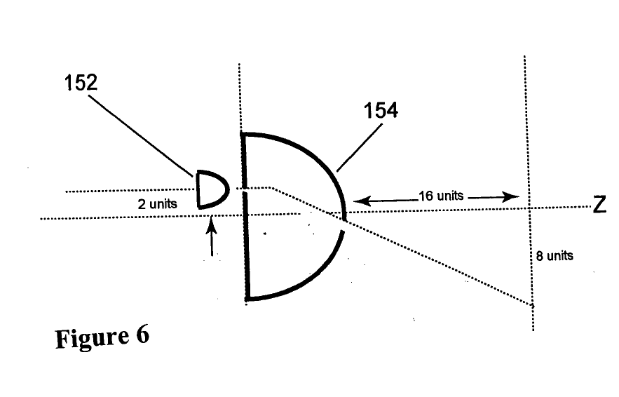

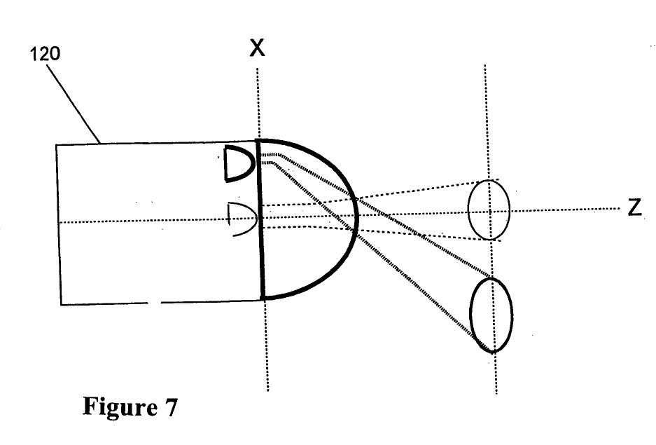

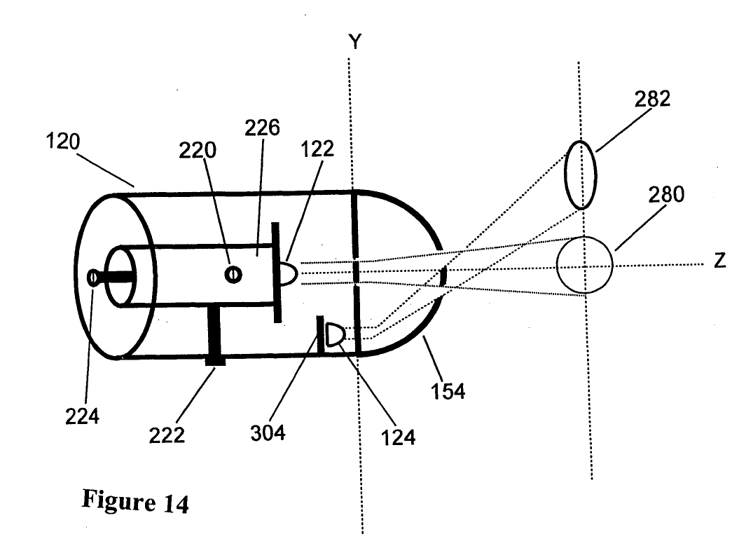

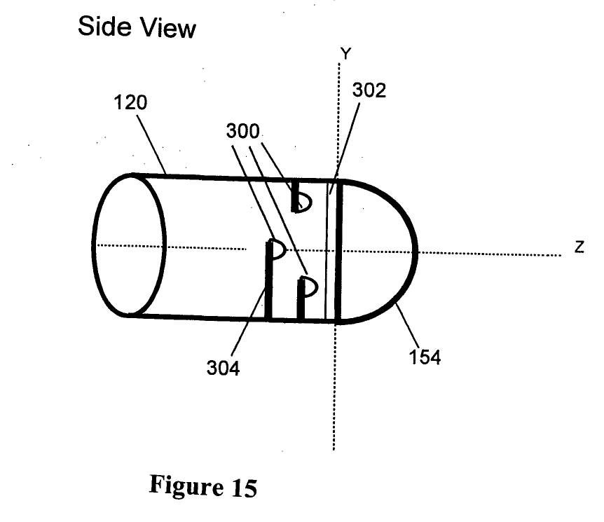

As depicted in FIG. 5, selectively illuminating one of a plurality of light sources positioned in the interior cavity and behind a lens 154 will allow selective illumination of first and second illumination points 156 and 158. Accordingly, an illumination pattern can be matched to an intended target. A large change in position of the illumination pattern from first and second illumination points 156 to 158 can be accomplished without a significant change in beam width, illumination pattern or light intensity. FIGS. 6, 7 and 8 provide examples of the relatively large change in the position and/or shape of the illumination point that can be achieved by shifting the light source a relatively small amount. It will be recognized that the change shown in FIG. 8 can be accomplished by either, or a combination of, selectively illuminating light sources positioned along the horizontal axis (or other appropriate axis), or by mechanically moving the light source. FIG. 14 shows a positional luminaire further provided with a fixed light source, and FIG. 15 is a side view of a positional luminaire consisting of three fixedly positioned light sources.

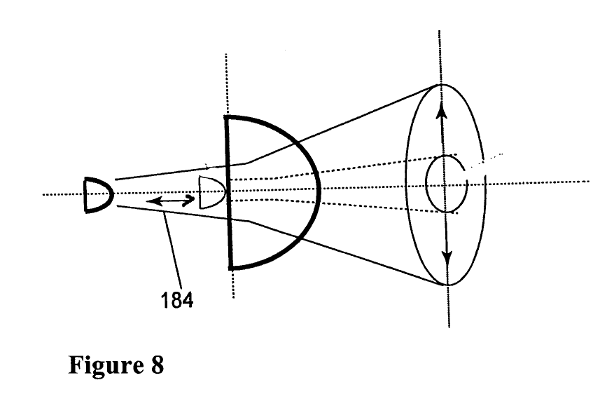

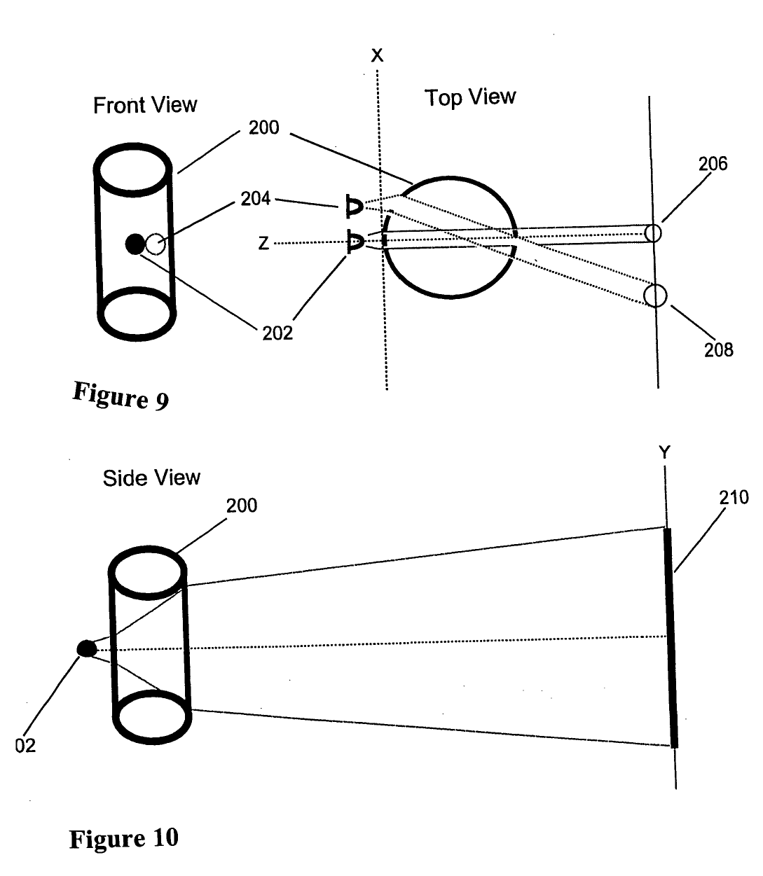

FIGS. 9 and 10 illustrate a rod lens that can be used with the positional luminaire of the present invention. It will be recognized that filters, stencils and masks can exists between the light source and lenses, or between successive lenses or on the outside of a lens in order to diffuse, colorize, blend, pattern, stylize or achieve specific design goals for the resultant light output. Lenses can be etched, masked coated, colorized or stenciled as needed. Depending on application, many different lenses exist including the rod lens, half-rod, sphere and conical lens. In addition, lenses or light guides can be added to the housing for the purpose of close proximity illumination. The inside of the housing can further be mirrored or coated in order to capture the relatively small amount of stray reflected light, though such reflective coating is not preferred with LED or fiber optic light sources.

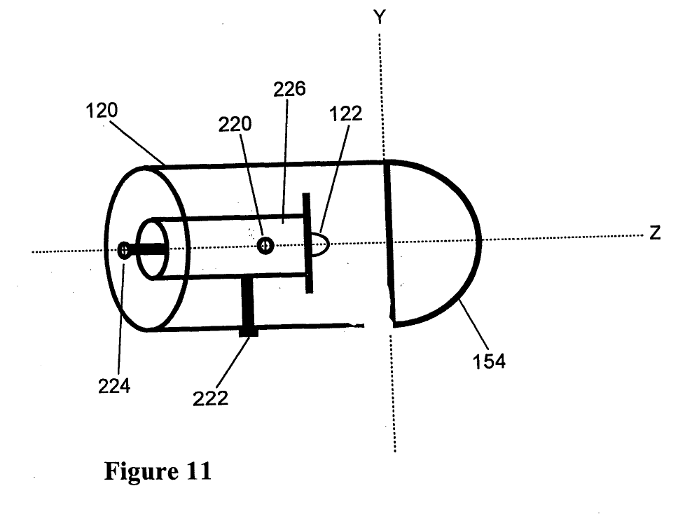

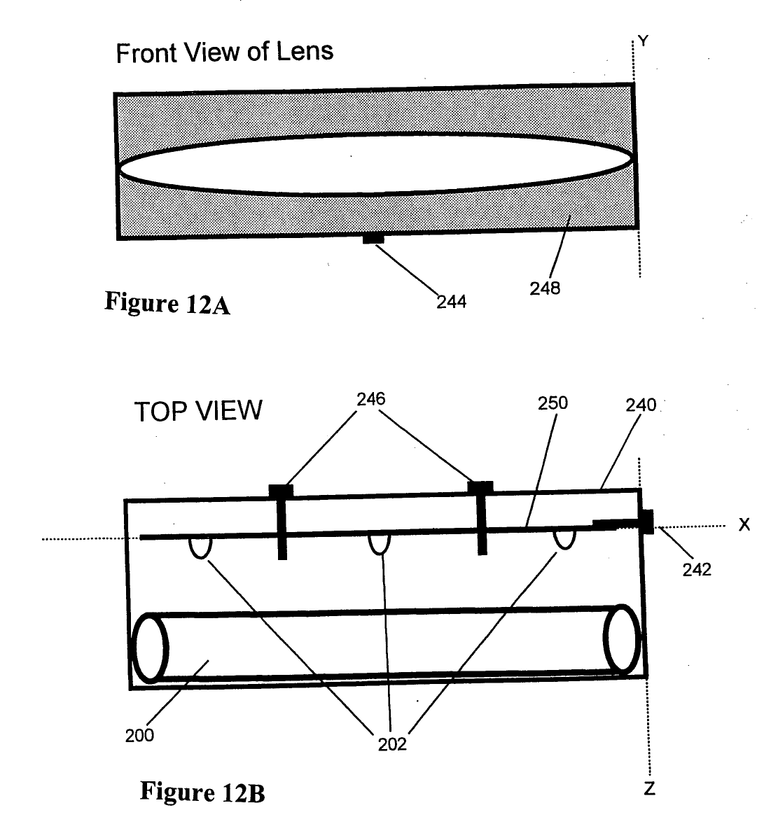

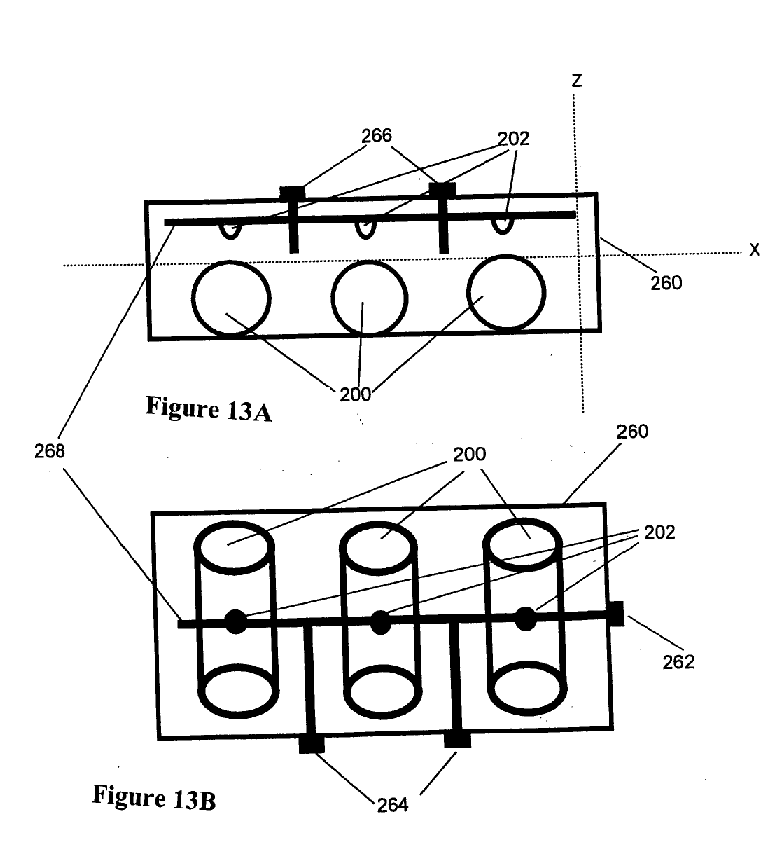

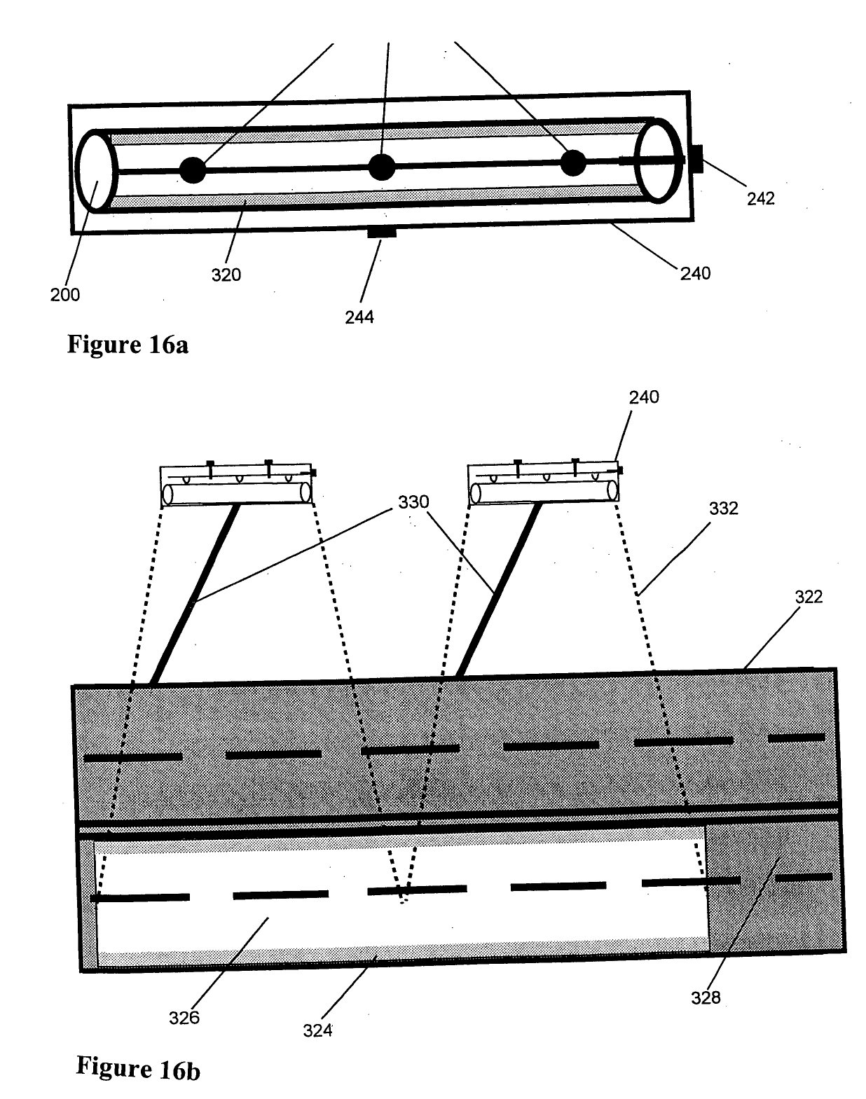

FIG. 11 illustrates a conical lens that can be used with the positional luminaire of the present invention, FIGS. 12A and 12B provide front and top views of the positional luminaire utilizing a rod lens and three light sources, and FIGS. 13A and 13B provide front and top views of the positional luminaire with a rod lens corresponding to each light source. Horizontal, vertical and longitudinal drives 242, 244 and 246, for adjusting the position of the light source, are preferably operated by remote or wireless control, thereby allowing for daytime installation and adjustment at night, avoiding the need to access the lamppost-mounted fixtures 240 (shown in FIG. 16B) and to allow for verification of appropriate illumination. FIG. 16B illustrates mounting the luminaire of FIG. 16A upon a roadway lamppost. As shown in FIG. 16A, longitudinal edges of a rod lens can preferably be etched.

One of skill in the art will recognize that the above-described invention has numerous applications, including in automotive lighting, landscape lighting, industrial lighting, residential lighting, marine lighting and billboard lighting.

While the invention has been shown and described with reference to certain preferred embodiments thereof, those of skill in the art will recognize that various changes in form and detail to the above embodiments may be made therein without departing from the spirit and scope of the invention, as defined by the appended claims.

1. A lighting fixture comprising:
a housing forming an interior cavity;
a holder positioned in and controllably moveable within the interior cavity to allow user-controlled movement from a predetermined home position to a plurality of enhanced lighting positions; and
a light source fixedly mounted to the holder; wherein movement of the holder focuses light output.

2. The lighting fixture of claim 1, further comprising a lens for focusing output light.

3. The lighting fixture of claim 2, wherein the lens is a tubular lens having etched edges for illumination of a roadway.

4. The lighting fixture of claim 1, further comprising a plurality of tubular lens for focusing light output corresponding light sources to adjustably illuminate a roadway.

5. The lighting fixture of claim 4, wherein each holder is mechanically adjustable.

6. The positional lighting luminaire of claim 1, wherein the lens is etched, masked, coated, colorized or stenciled to modify the output light.

7. The lighting fixture of claim 1, wherein the housing is recessed in a ceiling to provide downlighting.

8. The lighting fixture of claim 1, wherein user-control is accomplished by wireless control.

9. The lighting fixture of claim 1, wherein the holder is electro-mechanically moveable between the plurality of enhanced lighting positions.

10. The lighting fixture of claim 1, wherein the plurality of enhanced lighting positions are provided in horizontal, vertical and longitudinal directions.

11. The lighting fixture of claim 1, wherein the holder is hard wired to a power source.

12. The lighting fixture of claim 1, wherein a reflector is provided within the housing behind the holder.

13. The lighting fixture of claim 1, further comprising an additional light source fixedly mounted on the interior cavity of the housing, wherein the additional light source can be selectively illuminated.

14. A lighting fixture comprising:
a housing forming an interior cavity;
a plurality of light sources are positioned in horizontal, vertical and longitudinal positions in the interior cavity; wherein selective activation of the plurality of light sources focuses light output of the light source.

15. The lighting fixture of claim 14, wherein the light source is a Light Emitting Diode (LED).

16. The lighting fixture of claim 14, wherein the light source is a fiber optic light source.

17. A lighting method comprising
providing a luminaire having housing with an interior cavity;
positioning a holder in the interior cavity in horizontal, vertical and longitudinal directions; and
controllably moving within the interior cavity a light source between a predetermined home position and a plurality of enhanced lighting positions to focus the light source output.

18. The method of claim 17, further including a tubular lens having etched edges for focusing the output light.

19. The lighting fixture of claim 17, further comprising a plurality of tubular lens for focusing light output corresponding light sources to adjustably illuminate a roadway.

20. The lighting fixture of claim 17, wherein a holder of the light source is electro-mechanically adjustable.
